(19) United States
(12) Patent Application Publication
(10) Pub. No.: US 2015/0127559 A1
(43) Pub. Date: May 7, 2015

(54) METHODS AND SYSTEMS OF PROVIDING TEXT BOOK SHARING, MANAGEMENT, AND FUNDS MANAGEMENT

(71) Applicants: Vinay Kumar Asthana, Springfield, VA (US); Atul Chopra, Dubai (AE)

(72) Inventors: Vinay Kumar Asthana, Springfield, VA (US); Atul Chopra, Dubai (AE)

(21) Appl. No.: 14/528,218

(22) Filed: Oct. 30, 2014

Related U.S. Application Data
(60) Provisional application No. 61/899,893, filed on Nov. 5, 2013.

(51) Int. Cl. G06Q 30/06; G06F 17/30; G06Q 20/38

(52) U.S. Cl. CPC G06Q 30/0645; G06Q 20/38; G06F 17/30867
USPC 705/307

(57) ABSTRACT

A system and method for setting up (instantiating) and managing a book sharing system in a communication network. The system provides a software application that permits multiple users to participate in book sharing, and funds management. Method of book sharing include pre pay method, and a post pay method. The Book Sharing method shares the cost of books between all the users of the book, including all past users of the book. Pre pay book sharing adds a book to book sharing system and the first user pays for total cost of the book. As additional users use the book, the total cost of the book is divided among all the users of the book. In the post pay book sharing system, the total cost of the book is divided in the estimated number of users for the book. As the users are added, they pay for the book sharing.

### RELATED APPLICATIONS

This application claims priority to U.S. provisional patent application Ser. No. 61/899,893, entitled “Methods and Systems of Text Book Sharing, Management and Funds Management,” filed on Nov. 5, 2013, the contents of which are incorporated in their entirety herein by reference.

### BACKGROUND OF THE INVENTION

I. Field of Invention

The present invention relates to setting up and managing book sharing and funds management of a book sharing system offered via the Internet or other type of communications network. Any person can sign up to become a member of the book sharing system. As part of the book sharing membership, a user is allowed to purchase a new book for book sharing, or they can use a book that is already part of the book sharing system. This system is related to book sharing by users and management of funds by the book sharing system.

II. Background

Book sharing refers to use of a book by multiple users (not at the same time, but in succession). That is, one user purchases a book, and when they are done using the book, they can pass it on to another user, and all the users of the book share the total cost of the book. This kind of book sharing effectively reduces the net cost of a book for each user of the book.

It is becoming more and more the case that books used in the education system are getting expensive, and the users of these books have only the limited education period (like the semester) for the utilization of a book. By sharing the book with fellow users, the users of the book sharing system will share the cost of book, reducing the net cost of book ownership, and they can have the full benefit of having the book at their disposal when they need to use the book for the period they need to study the book.

Book sharing concepts exist in terms of swapping books with other reader(s). However, due to the high cost aspect of some of the books in the education system (e.g., High School and College), book swapping is not a cost effective means to mitigate the high cost of books.

### SUMMARY OF THE INVENTION

With the cost of higher education going up, one of the factors for cost in higher education is the cost of books and materials required by the students for their classes and course work. In order to help reduce the net cost of books that a student will use for a limited amount of time, typically a semester, a Book Sharing System will help distribute the cost of using the book for the users of the book, as books are used only for a short period of time, e.g., for a semester. In particular, a book sharing system where besides the book sharing, the cost of the book is also shared by multiple users, is an effective system to reduce the cost of books for the users of the book.

At least one embodiment is directed to system and that method provides for sharing of book among the interested users of the book. In sharing the book, the cost of the book is distributed among the users of the book.

There are two ways of participating in the Book Sharing System. A user can be involved in a Pre Pay Book Sharing method (or model), or a Post Pay Book Sharing method (or model).

A Pre Pay Book sharing method allows the first user to pay the full price of the book, and as the book can be passed on to other users of the book, the payment of the book collected from the subsequent users is compensated to the past users of the book, thereby spreading the total cost of the book across all the users of the book. Cost of ownership of the book is divided among the number of users of the book. The first user will pay 100% of the cost of the book, the cost of the book for the second user will be 100%/2=50% of the cost of the book, the cost of the book for the third user will be 100%/3=33.33% of the cost of the book, and so on.

A Post Pay Book Sharing method allows for the cost of the book to be distributed among a pre-determined set of users, and the cost of the book is divided among the pre-determined set of users. Typically the life of the book is estimated to be in range from 2, 3, 4 users of the book. Accordingly, based on the distribution expectancy, the cost of the book is distributed among the users. For a book with estimated life of four (4) users, the initial cost of the book for each user of the book will be 100%/4=25%.

The Pre Pay Book Sharing method starts with a user searching for a book, by identifying the information about the book. The user is charged for the full cost of the book plus any book share handling fees (e.g., a fixed fee, e.g., $5, or a percentage of the cost of the book, e.g., 5% of the book cost). A book is purchased and provided to the user by any means available (e.g. regular postal mail, courier mail delivery). The Total Cost of the book is registered in the Book Sharing system. When the user is done with the book, they can inform the Book Sharing system that the book is available for the next user. The book is listed on the Book Sharing System as available for the next user along with an updated cost of the book. When another user shows interest in the book from the Book Sharing System, and makes the payment for the book, the payment amount is computed by the Book Sharing system based on the number of users of the book. The current owner of the book is notified to hand over the book to the new user via shipping using standard shipping methods, or by personally handing the book to next user in person (if they are located hereby each other and agree to this method of book handover). Once the book handover is completed, the payment collected from the new user of the book is distributed among the past owners of the book. This cycle will continue, until the current owner of the book does not want to list the book ready for next user due to any reason, such as the book is worn out, the user wants to keep the book for reference, etc.

The Post Pay Book Sharing method starts with a user searching a book by providing identifying the information about the book in the book sharing system (e.g., entering information in a book search web page of the book sharing web site). The Book Sharing team specify the typical life expectancy of the book, e.g., between 2, 3, or 4 users. This may be done based on whether the book is paperback or hardcover, how large or small the book is, the adjudged quality of the book binding, etc. The total price of the book is divided into the expected number of users. The per-user price of the book plus any book sharing financing/handling fee is added to compute the total cost of the book for the current user/buyer of the book. The Book Sharing system s purchases and supplies the book to the user. When the current user is done with the book, the current user can inform the Book Sharing system that the book is available for the next user. The book is then listed on the Book Sharing system as available for the next user. If another user identifies and pays for the book and requests use of the book, the current user of the book is notified to pass the book to the next user as identified by the book sharing system. At this point, the second user of the book makes a payment as computed by the Post Pay Book Sharing method. If no other user claims the book within a pre-determined time (e.g., two weeks into the current semester), the current owner keeps the book, and pays for the remainder of the cost to pay the Book Sharing system towards the total cost of the book. In this manner, the cycle of users will continue until it reaches the end of number of users established for the book share, or a user is not able to pass the book to the next user. If the user fails to pass the book on to the next user, that user is liable for any outstanding costs determined towards the total cost of the book, by the book sharing system.

### BRIEF DESCRIPTION OF THE DRAWINGS

FIG. 1 Illustrates a process flow for initiating Book Sharing according to an embodiment.

FIG. 2 Illustrates a process for a user to make requests for book sharing according to an embodiment.

FIG. 3 Illustrates a process to request a new book to be added for book sharing according to an embodiment.

FIG. 4 Illustrates a process for requesting an existing book for book sharing according to an embodiment.

FIG. 5 Illustrates a process of participating in Pre-Pay Book Sharing for a new book according to an embodiment.

FIG. 6 Illustrates a process of participating in Post Pay Book Sharing for a new book according to an embodiment.

FIG. 7 Illustrates exemplary calculations for Pre Pay Book Sharing according to an embodiment.

FIG. 8 Illustrates exemplary calculations for Pre Pay Book Sharing for up to 4 users according to an embodiment.

FIG. 9 Illustrates exemplary calculations for Post Pay Book Sharing according to an embodiment.

FIG. 10 Illustrates a process of transfer of a book to a subsequent user according to an embodiment.

FIG. 11 shows network communications components of an online book sharing system according to various embodiments.

FIG. 12 shows a block diagram of a computer system for which various embodiments of the invention can be implemented.

### DETAILED DESCRIPTION

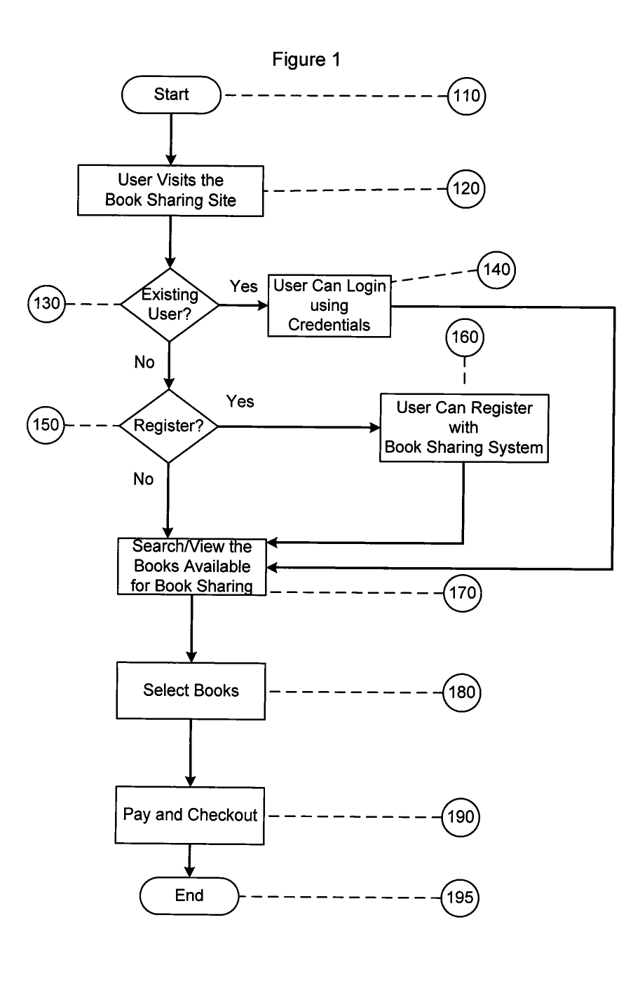

FIG. 1 illustrates a main process flow for initiating book sharing according to an embodiment. The main flow is for any user, member or non-member, who can become an authenticated member of the book sharing system, a member user can then log into the system using their credentials (e.g., username and password). Any user can view the contents of the book sharing system. Any non-member can register to become a member of the book sharing system.

In FIG. 1, Block 110 illustrates the start of the Book Sharing Process by the user accessing the Book Sharing Website.

In Block 120, any user visits (accesses) the Book Sharing Website using a published Uniform Resource Locator (URL) using a web browser, for example.

In Block 130, any registered member of the Book Sharing system can proceed to Block 140, and log into the website. If the user is not an existing member of the Book Sharing system, the system proceeds to Block 150.

In Block 140, a registered member of the Book Sharing System can log in to the website using their credentials (e.g., username and password).

In Block 150, if a user wish to register themselves with Book Sharing system, they are presented with a Registration process as indicated in Block 160.

In Block 160, the user is presented with a registration form (e.g., provided on a registration web page or screen on the book sharing web site), and the user can register themselves via inputting information onto the Registration Screen, whereby the user can provide their personal information, and information pertinent to book sharing preferences.

In Block 170, any user can search or view the books available in Book Sharing system. The user can perform the search by entering information about the book they are looking for (e.g., title and/or author of the book and/or version number of the book).

In Block 180, the user is presented with the list of books found in the Book Sharing system as a result of the search, and the user can select the book they were looking for, and add the book to an ecommerce cart (e.g., checkout cart).

The search result may include new books, and books already in the book sharing system. The user can view the details of the book, and select new books, or books already in book sharing system following a Pre Pay method or a Post Pay method.

In Block 190, the user can make the payment for all the books selected and placed in the ecommerce cart. Payment may be done via any payment method provided by the Book Sharing System, such as by the user inputting his/her credit card information or bank account information, or by using a third party payment process (e.g., PayPal™).

The user during the checkout process selects the shipping method for collecting the book. Shipping methods include shipping using standard shipping services, or in the case of a book already in the book sharing system, the user can collect the book in person from the current book holder if it is mutually convenient to do so to the current holder of the book and the user who has just paid for the book.

In Block 195, it illustrates the completion of the purchase of a book using the Book Sharing System. This is the high level book sharing book purchase process, whereby additional details of the book sharing are detailed in the following figures.

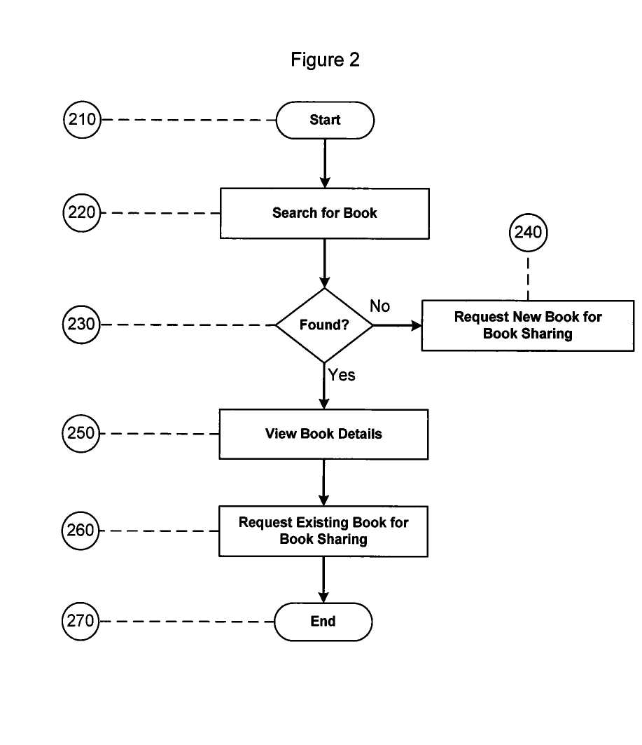

FIG. 2 illustrates a process for a user to search for book for sharing according to an embodiment. Any user who has accessed the book sharing system can perform a search for the book they need.

If the book is found in the book sharing system the user can view details and select the book from book sharing. If the book is not found in the book sharing system, the user can purchase a new book for book sharing.

At start point 210 in FIG. 2, any visitor of the book sharing system website and initiate the search for the book they need.

The process proceeds to Block 220 in FIG. 2, for searching for a book. When a user is interested in obtaining a book from the book sharing system, the user can perform a search for the book within the website. This can be done by the book sharing system querying a database that contains the books that belongs to the book sharing system as well as the books which can be purchased and added to book sharing system (e.g., books obtainable from a brick-and-mortar bookstore or from an on-line bookstore).

In Block 230, the process performs a check to determine if the book exists in the book sharing system database, and displays the result of the search accordingly, if the book is found, the details of the book, and the book sharing plan (example, Pre Pay or Post Pay method of book sharing plans), etc. If the book is not found, the user is prompted to purchase a new book and enroll in Book Sharing using appropriate Book Sharing method (Pre Pay or Post Pay).

In more detail, if the book is not found based on the search performed in Block 230, then the process proceeds to Block 240, in which the user is prompted by the website to purchase and addi the book to the book sharing system. To perform this, the process control may then be transferred to a component (e.g., software application) which helps a user create and submit a request to the book sharing website for a new book to be used for book sharing.

If the book is found based on the search performed in Block 230, then in Block 250 the details of the book are displayed for the user to review (e.g., cost, quality of the book, and information as to the number of prior users of the book).

After being provided with the book details in Block 250, the process proceeds to Block 260, to enable the user to select the book. In Block 260, if the user desires, the user can request the existing book in the book sharing system. The process control may then be transferred to a component (e.g., software application) which helps a user requestfor acquiring a book using existing Book Sharing method (Pre Pay or Post Pay), which is already present in the book sharing system.

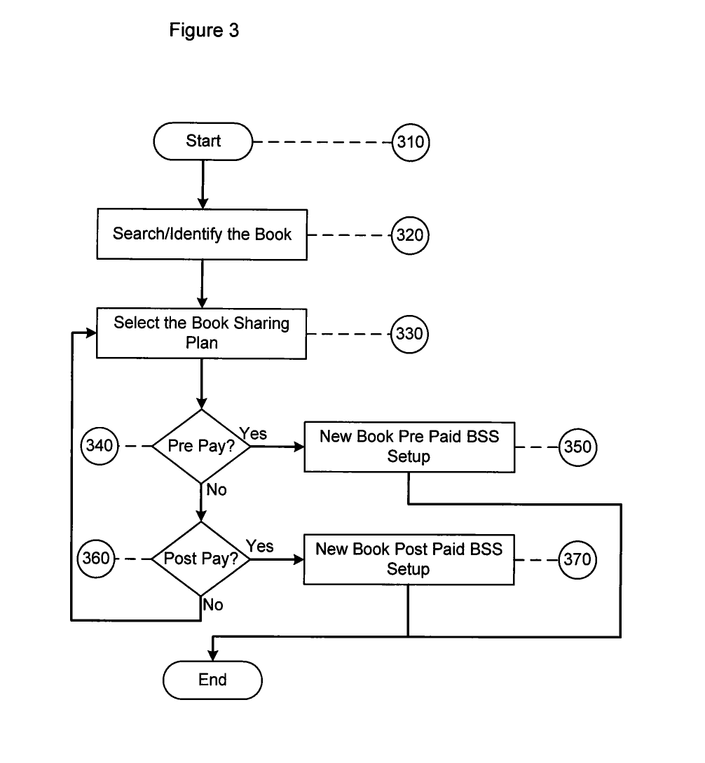

FIG. 3 illustrates a process to purchase a new book to be added for book sharing according to an embodiment. If the book that the user is looking for does not exist in the book sharing system (i.e., the book is not available for sharing), the user can purchase a new book for book sharing. The request for new book sharing includes reviewing of the two methods, that is, the Pre Pay book sharing method, and the Post Pay book sharing method. The user reviews the funds management information regarding the selected book sharing plan and selects the book sharing plan suitable to them. Once the user selects the appropriate book sharing method, the control is transferred to a component (e.g., software application) that completes with new book purchase for book sharing.

In more detail, the process starts at start Block 310 in FIG. 3. At this point, any user or visitor to the book sharing system can search a book for book sharing. If the book is not found, so the user can select to purchase a new book to be added to the book sharing system.

The process proceeds to Block 320, in which the user is presented with the details of the book that the user is looking for, to allow the user to identify the book that the user wants.

The process then proceeds to Block 330, in which the user is presented with the book sharing options, in which a primary option is selection of either the Pre Pay book sharing method (or model) or the Post Pay book sharing method (or model). The user may also be presented with the details of the book sharing options with funds management information, so the user can make an informed decision as to the book sharing system that is most suitable to them.

In Block 340, if the user selects the Pre Pay book sharing method for the new book that user has identified for book sharing (‘Yes’ output line from Block 340), in Block 350 the control is transferred to a component (e.g., software application) that will help user complete the purchase to a pre pay book sharing.

The component utilized in Block 350 provides helps to the user for purchasing a new book for book sharing using the Pre-Pay Book sharing system method, and adds the book to the user's ecommerce cart, which can be checked out.

If instead the user selects the Post Pay book sharing method for the new book that user has identified for book sharing (No output line from Block 340), the process proceeds to Block 360, whereby control is transferred to a component (e.g., software application) that will help the user complete the purchase to a post pay book sharing.

The process proceeds then to Block 370, which provides help to the user for purchasing a new book for book sharing using the Post Pay Book sharing method, and adds the selected book to the ecommerce cart, which can be checked out later by the user. If the user does not pre pay or post pay, the process returns back to Block 330, to allow the user to select a different book for book sharing.

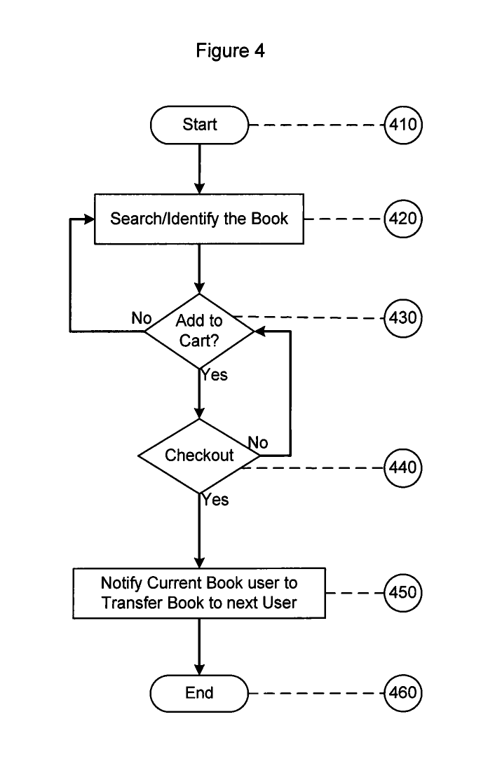

FIG. 4 illustrates a process for requesting an existing book (an existing book is a book available in the book sharing system, and available for sharing) for book sharing according to an embodiment. That is, when the user was looking for a book at least one book was found, and user has selected that one book, and the user wants to submits a request regarding the book for book sharing.

The process starts at Start Block 410 whereby the user has accessed the book sharing web application using a browser.

The process then proceeds to Block 420, in which the user will search and identify the book they are looking for. As a result of the search, results of the search are displayed providing details of the book. At this point, the user has the option to select the book by adding the book to the ecommerce cart.

The user can add the book to the ecommerce cart, as indicated in Block 430, in which the user selects the book for book sharing, and the associated method for book sharing, and is then presented with the cost of book sharing.

The user can pay for the book sharing via an online payment method, for example, by providing their credit card and/or bank account information. If the payment is made and is successful as determined in Block 440, the process is moved on to validation of the payment. If the user payment was not successful, the system will display the previous display of ecommerce cart, and the process will return back to Block 430 to allow the user to checkout the ecommerce cart on the website.

In more detail, a component (e.g., software application) can be used in Block 440 that validates the online payment from the user for book sharing. If the payment for book sharing was successful, the control is moved to the next component (Block 450), else the user is asked to make the corrections and make the payment by returning the process back to Block 430.

If the payment was successful, the process proceeds to Block 450, whereby a component (e.g., software application) sends a notification to the current user of the book to pass the book to the next user of the book.

The process ends in End Block 460, which marks the culmination of one transaction, that is a user requesting an existing book for book sharing.

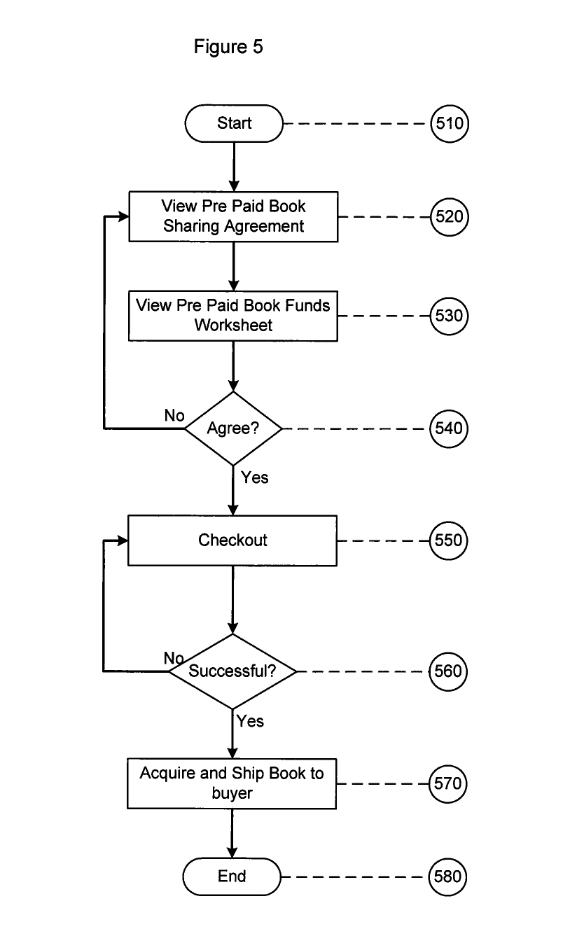

FIG. 5 illustrates a process of participating in Pre Pay Book Sharing for a new book, in which the book that the user was looking for is not found in the existing books in the book sharing system. As such, the user wants to purchase the book and added to the book sharing system using the pre pay book sharing method.

The process starts in Start Block 510, whereby the book that the user is looking for is not in the Book Sharing system, and whereby the user wishes to purchase and addthe book to the book sharing system using pre pay method.

In Block 520, the user is presented with the details of a Pre Pay Book Sharing agreement for the user to review. This agreement may include such things as: a) acceptable methods to send a book to the next user (e.g., standard shipping methods, or via a person-to-person book transfer), and the time frame by which the user must send the book to the next user after having been notified by the book sharing web site to transfer the book to another user).

The process then proceeds to Block 530, in which the user is presented with the details of the funds management for the pre pay book sharing system specific to the book in question.

In Block 540, the user is asked if they agree with the pre pay book sharing agreement, and if they agree with the funds management presented to them. If the user does not agree, the control is sent back to Block 520.

If the user agrees, such as by clicking on an “Agree” icon or radio button on a web page presented to the user, the control is sent to a checkout or collect payment component that is used to perform Block 550.

In Block 550, a component (e.g., software application) provides a mechanism to allow the user to pay for the book in the book sharing system using the online payment methods.

In Block 560, the process validates if the payment for the book was successful. If the payment was not successful, the process returns back to Block 550, and the user is asked to edit the payment information, and submit the payment again.

If the payment is successful, the process proceeds to Block 570, and the Book Sharing system will purchase and send the book to the user.

The pre pay purchase process ends in End Block 580, which is the culmination of the process which involves the user purchasing the book using the Pre Pay Book Sharing method, and make the payment for the book.

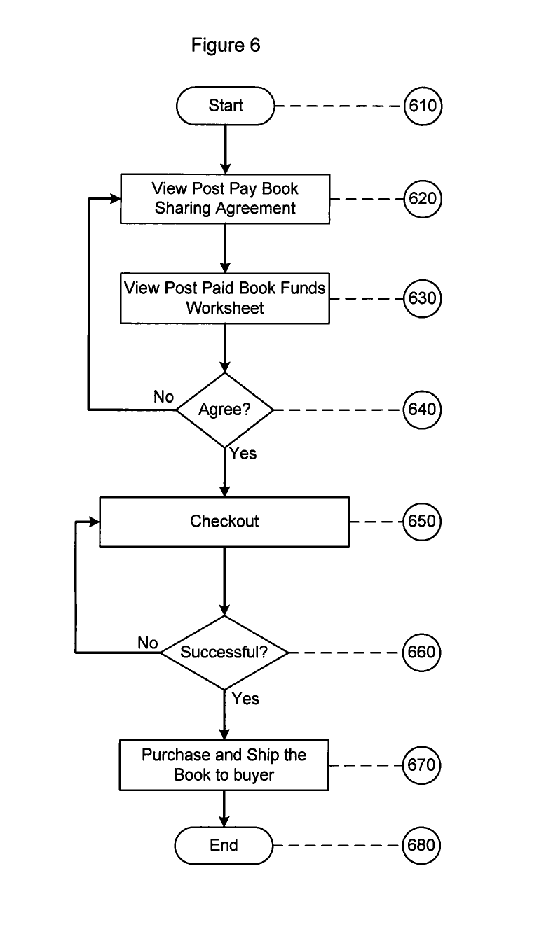

FIG. 6 illustrates a process of participating in Post Pay Book Sharing for a new book according to an embodiment. The book that the user was looking for is not found in the existing books in the book sharing system, whereby the user can request this book to be added to the book sharing system using the post pay book sharing method.

In Start Block 610 in FIG. 6, the book that the user is looking for is not in the Book Sharing system, and the user wishes to purchasing and adding the book to the book sharing system using the post pay method.

In Block 620, the user is presented with the details of a Post Pay Book Sharing agreement for the user to review. This agreement may include such things as: a) acceptable methods to send a book to the next user (e.g., Standard shipping methods, or in person), and the time frame by which the user must send the book to the next user after having been notified by the book sharing web site to transfer the book to another user, and financial responsibilities if the book is not shared further.

In Block 630, the user is then presented with the details of the funds management for the post pay book sharing system specific to the book in question.

In Block 640, the user is asked if they agree with the post pay book sharing agreement, and agree with the funds management presented to them. If the user does not agree (‘No’ line output from Block 640), the control is sent back to Block 620. If the user agrees (‘Yes’ line output from Block 640), the control is sent to a checkout or collect payment component (e.g., software application) to continue the post pay book sharing method.

In Block 650, the user is allowed to pay for the book in the book sharing system using the online payment methods.

In Block 660, a validation is made to determine if the payment for the book was successful. If the payment was not successful (‘No’ line output from Block 660), the user is asked to edit the payment information, and submit the payment again, by return of the process back to Block 650.

If the payment is successful (‘Yes’ line output from Block 660), the process proceeds to Block 670, and the Book Sharing system will purchase and send the book to the

The post pay purchase method ends in End Block 680, which is the culmination of the process that involves the user purchasing the book, and make the payment as per the post pay method.

In some embodiments, for Post Pay book sharing. if the user holding the book purchased via Post Pay Book Sharing method, and the book is not shared further, the user holding the book is responsible for an outstanding liability on the book. If the user failto pay the required outstanding liability of the book if no one borrows the book for any reason after the user is done with the book using the post pay method. For example, such as if the user is the first user and there is no other user who wants to borrow the book after the first user has finished using the book (e.g., at the end of the current college semester), the user is shown in the book sharing web site as having a negative (−) rating if the user has not paid the required outstanding liability within a predetermined amount of time (e.g., 7 days) after having been notified by the book sharing web site to make the payment for outstanding liability. That way, people will be made aware that this user is not meeting the requirements set forth in the post pay agreement they signed, and thus any future potential borrowers of books currently in possession of this user are put on a warning notice. As such, this user may find it more difficult to share books using the book sharing web site with such a negative rating assigned to the user.

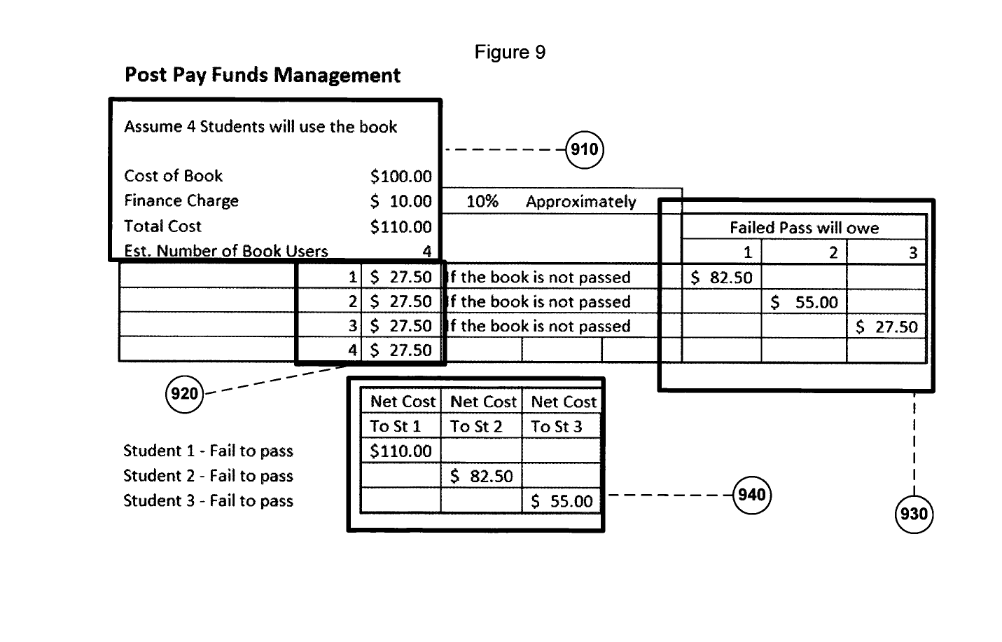

In other embodiments, a person using the post pay method has to agree to have a particular credit card amount (e.g., total cost of the book say $200) put in escrow, so that if that user does not fulfill the rules as set forth in the post pay agreement, some or all of the escrow amount will be taken from the user to pay off the required debt owed by the user. For example, referring now to FIG. 9, if the second user is not able to pass the book on to another user, then the second user owes $55.00 to the book sharing web site. If the second user does not pay the $55.00 to the book sharing web site within a fixed time period after having been notified, e.g., within 7 days, then a $200 credit card hold “escrow” amount of that user is debited so as to pay the system the $55.00 that the user owes to the system. Additionally, the user is given a negative rating in the system, to warn others that this user may be untrustworthy.

If a user who has not paid for an amount owed to the system using the post pay method after being notified that they have to pay the remaining amount owed for borrowing a book, that user may in the future try to subvert the system by re-registering under a different username, password, and/or email address, so as to remove any negative rating previously assigned to that user by the book sharing web site. In this instance, when the user then provides his/her bank information and/or other personal information to the book sharing web site during the registration process, that information is compared to personal information of existing registered users with negative ratings, to see if there are any partial or complete matches. If, for example, the mailing address information of a user attempting to register onto the book sharing web site matches mailing address information of a previously-registered user who was provided with a negative rating, then the current user is blocked from registering onto the web site. Also, information regarding that user not fulfilling the post pay agreement that they had agreed to is provided to various other sources, such as credit rating services, banks, and/or collection agencies, to thereby give that user a negative credit mark that may affect the user's ability to perform financial transactions. As described above, in some embodiments, when a user desires to borrow a book currently in the possession of another user, a rating assigned to that other user is provided to the user, so that the user can decide whether or not he/she is willing to trust that the other user will mail the book to him/her in a reasonable time frame (e.g., within three to four business days after being informed to pass the book on to another user).

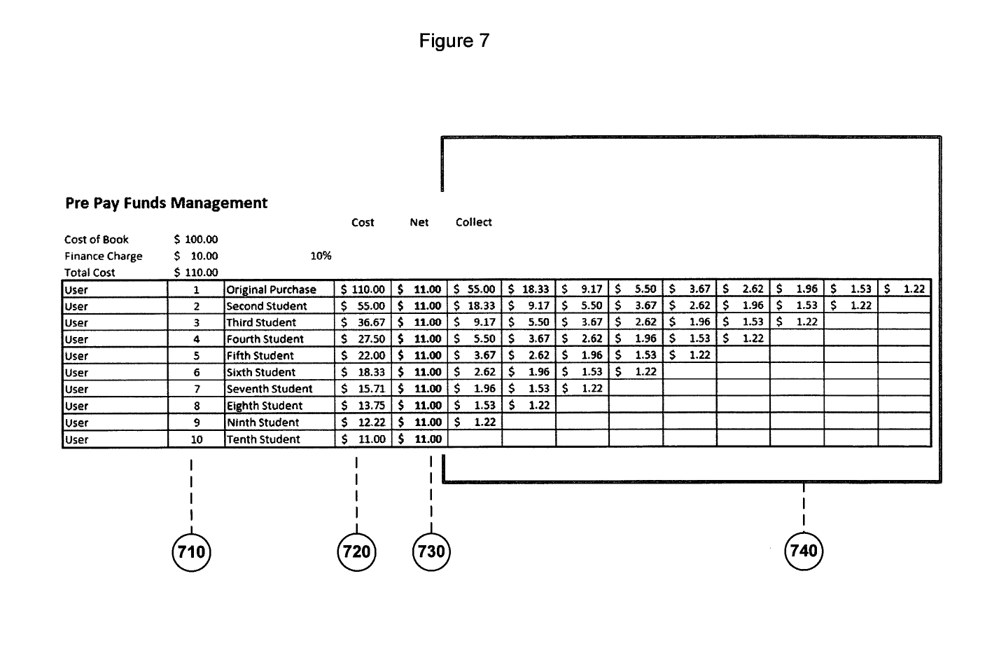

FIG. 7 illustrates exemplary calculations for Pre Pay Book Sharing according to an embodiment. Pre Pay book sharing allows the first user to pay for the cost of the book. As the book is passed to successive users the total cost of the book is divided among the users of the book. For example, if the original cost of the book is $100, and there is say 10% charge for book sharing handling (the book sharing handling fees will vary based on the operator of the book sharing system), so the total cost of the book is $110 that is $100+10% fees=$110. When the first user (User 1) requests the new book using Pre Pay book sharing, they will pay the entire $110 to the book sharing system, and they will receive the book. When they are done using the book, they can inform the Book Sharing system that the book is available for any user of the book sharing system. When the next user (User 2) selects the same book, the total cost of the book is divided between the two users, so second user will make a payment of $110 divided by 2, that is $55 or similar calculation referring to distribution of cost between the users of the book. Using the illustrated example, the payment from second user is sent to the first user, reducing the first user's net cost of the book to only $55; that is, $110-$55=$55. When the book is passed to the subsequent user (User 3) of the book, there are three users (two former users and one current user), so the cost of the book is divided among the three users; that is $110/3=$36.67 (or similar calculation, distributing the total cost of book among all the users of the book), and the payment made by the third user is passed to the previous users of the book. Using the illustrated example, that is, User 1, and User 2 with both receive equal payment of $36.67/2=$18.33. As more users use the book, the less they will have to pay, and their payment is passed back to the previous users of the book reducing the net cost for all the users of the book. As more users use the book, the total cost of the book is distributed among the users, reducing the net cost of book for each user.

Column 710 in FIG. 7 shows the number of users that the book is passed in the book sharing system.

Column 720 in FIG. 7 indicates the initial cost to the users of the book, as the users are added for the book, the cost of the book is divided among all the users, resulting in lower cost of using the book for all the users. For example, the first user will initially pay $110 for the book, the second user will initially pay $55 for the book, the third user will initially pay $36.67 for the book, and so on. In some embodiments, the quality of the book is also provided on the book sharing web site, and is provided to the user along with the books found in his/her book search, such as a book being in “fair” condition, “good” condition, or “excellent” condition.

Column 730 in FIG. 7 indicates the net cost to the user if the book is shared among 10 users.

Region 740 in FIG. 7 corresponds to a set of columns that the user will collect as the book is passed to more users of the book. Row 1 indicates the amount of money user 1 will collect as the book is passed around. When the book is passed to user 2, the payment from user 2 will go to user 1. When user 3 makes a payment, it is divided equally in two parts and sent to the two previous users of the book. When user 4 makes a payment, it is divided equally in three parts (three as there are three past users of the book in book sharing), funds from user 4, is sent to past three users, and so on. Row 2 indicates the amount of money user 2 will collect as the book is passed around. These are sample calculations, the calculations can be different, but the key idea is that the total cost of the book is distributed among all the users of the book. In some embodiments, each time a payment is made to past users, the book sharing system obtains a fixed percentage of that amount, as a processing fee (e.g., 10% of the total fees to be passed on to past users).

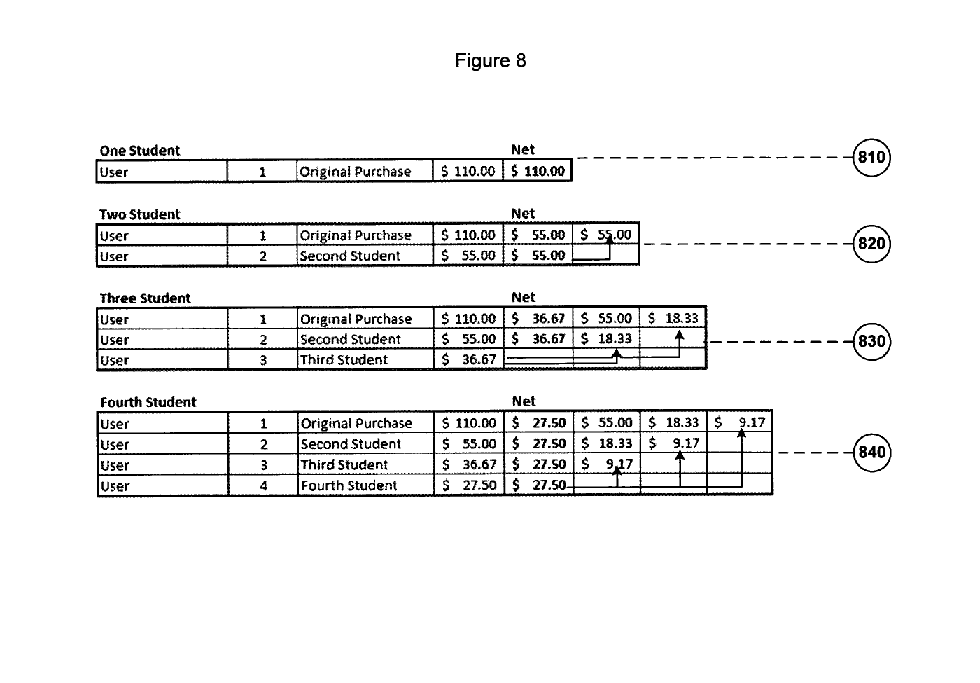

FIG. 8 illustrates exemplary calculations for Pre Pay Book Sharing in an embodiment for up to four (4) users (in the given example). FIG. 8 provides detailed information for each user for the book, up to 4 users. Note that the life of the book in the book sharing system may not necessarily end with just 4 users, as in this example. That is, the book may continue to be passed as long as it is in good shape for another user to use the book.

Region 810 in FIG. 8 shows the funds for the first user, if they purchase the book in Book Sharing system, and the book is not passed to another user. If the book is not shared with another user, the current user will bear the total cost of the book in the Pre Pay method.

Region 820 in FIG. 8 shows the funds for the first two users of the book sharing system using the pre pay method. User 1 will pay the total price of the book, and when the user two is interested in the book, the second user will pay only $110/2=$55 (or similar amount, showing distribution of cost of the book between the users of the book), and this $55 is passed back to user 1, making the net cost of book same to both the users.

Region 830 in FIG. 8 shows the funds for the first three users of the book sharing system using the pre pay method. Cost of the third user (user 3) is Total cost of the book divided among all the userd of the book. For the given example, that is $110/3=$36.67. So user 3 will make a payment of $36.67. This payment is divided between the past users, in this case there are two past users of the book. User 1, and User 2, both of whom will collect $18.33, reducing net cost of the book down to $36.67 for all the users.

Region 840 in FIG. 8 shows the funds for the first four users of the book sharing system using the pre pay method. Total cost of the book for user number four is total cost of the book divided among all the users of the book. For the given example, that is $110/4=$27.50. So the fourth user (User 4) will make the payment of $27.30 for the book. This payment is divided and distributed between the past users of the book, in this case there are 3 past users of the book. User 1, User 2, and User 3 will collect $9.17, reducing net cost of the book down to $27.50 for each user. In some embodiments, User 1, User 2 and User 3 will collect an amount less than $9.17, whereby a processing fee (10% of the cost made by User 4, or $2.73) is provided to the book sharing web site to cover expenses and processing fees associated with running the book sharing web site.

FIG. 9 illustrates exemplary calculations for Post pay book sharing according to an embodiment. Post pay book sharing principle factors the total cost of the book, and an estimated number of users for the book. The estimate for the number of users of the book is conservatively 2, 3, or 4 users only, and the estimation is provided by the book sharing system. This embodiment is not limited to this amount of users, and it is up to the discretion of a book sharing system operator to decide that. For the illustration as shown in FIG. 9, the estimated number of users for the book is 4. So, the total cost of the book is divided into 4, and that is the total cost of use for the user of the book in book sharing system. So first four users of the book will pay at least 27.50, and whereby the first user will have an outstanding liability for $110-$27.50=$82.50 which is applicable if the book is not shared further with another user. As the book is passed to another user, the responsibility of book sharing is also passed on. That is, the first user paid $27.50 for book sharing, but fails to transfer the book to another user, or no one selects that book from book sharing, the first user will be responsible for the outstanding liability which is total cost of the book minus what is paid for the book by the user. If the user passes the book successfully to subsequent user, they are free of any further liability to the book sharing system for the current book. User 2 will make the same $27.50 payment for the book, will have an outstanding liability for $110427.50427.50455 and will receive the book. If they fail to pass the book to another user, they will be responsible to pay for to outstanding liability which is total cost of the book minus what is paid for the book by the users of the book. So if the second user fails to pass the book to subsequent user, they will owe an additional $55 to book sharing system. But if they pass the book successfully to subsequent user, they are free of any further liability to the book sharing system for the current book. User 3 will make the same $27.50 payment for the book, will have an outstanding liability for $110-$82.50=$27.50 and will receive the book. If that user fails to pass the book to subsequent user, they will be responsible to pay for the outstanding liability which is total cost of the book minus what is paid for the book by the users of the book. Similarly for the fourth user, the cost of the book is $27.50. At this point, all other users of the book are free of any liability for the current book. In this example, the fourth user is not obligated to pass the book to any subsequent user. Any user in the Post Pay book sharing method, after paying the full price of the book, may roll the book over into the Pre Pay method, thereby helping them reduce the cost of the book.

Circled region 910 in FIG. 9 shows the core factors for the book sharing, and sample numbers like Cost of the book $100, a Book sharing fee of 10%, making the total cost of the book to be $110. Estimated number of users (estimate of number of users is provided by a book sharing system operator) for the book are four (4), that is the initial cost of the book for each user is $110/4=$27.50.

Circled region 920 in FIG. 9 shows the initial cost of the book for each of the four users. The cost of the book is calculated by dividing the total cost of the book by the estimated number of users of the book.

Circled region 930 in FIG. 9 shows the outstanding liability of the book a user has to pay if they fail to pass the book to subsequent user for any reason. A user after paying the outstanding liability, can roll the book over to the pre pay book sharing system if they wish to reduce the cost of book for them. So for the given sample, if user 1 fails to pass the book to user 2, they will be charged additional $82.50. If user 2 fails to pass the book to user 3, they will be charged additional $55. If user 3 fails to pass the book to user 4, they will be charged additional $27.50. User 4 is not obligated to pass the book to another user. The additional cost charged or the outstanding liability to the user is calculated by Total cost of the book minus the sum of payments made by the users of the book.

Circled region 940 in FIG. 9 shows the total cost of the book to the user for the given sample to each user if they fail to pass the book to subsequent user. If user 1 fails to pass the book to user 2, their total cost of using the book will by $110 in the given sample. If user 2 fails to pass the book to user 3, their total cost of using the book will by $82.50 (that is, ¾ of the cost of the book). If the user 3 fails to pass the book to user 4, their total cost of using the book will be $55 (that is, ½ of the cost of the book).

The above-described information is provided to the user in the book sharing web site, so that the user can decide whether or not to borrow a book using the pre pay method or the post pay method. Referring to FIG. 9, the second user is informed, prior to agreeing to take the book from the first user of the book, that he/she is liable for outstanding liability if the second user is not able to pass the book on to another user at some later point in time, and whereby the second user is liable for zero dollars if the second user is able to pass the book on to another user. Referring to FIG. 8, that same book may be available using the pre pay method if the user is the second person using the book, and thus the cost of the book for second user of the book will be $55.00. As the book is passed to the third user, funds from the third user will help reduce the net cost of the book and whereby the first and second user is each provided with $18.33 in his/her account if second user is able to pass the book on to a third user after the second user is done using the book. This information is helpful for a user in deciding whether or not to use the post pay method or the pre pay method for borrowing a particular book.

In some embodiments, each book in the book sharing system includes information regarding how many times it has been previously passed on, so that a user can determine the liabilities associated with obtaining that book, using either the pre pay method or the post pay method. For post pay books with outstanding liability more then $0, if the current user of the book is not able to pass on the book after a preset period of time, e.g., after 15 days into the current semester, the user equipment associated with the user is notified by way of a ‘Pay Now’ notice (e.g., email, text message, and/or recorded telephone message to the telephone number entered by the user during the user's registration onto the book sharing web site), whereby the user must then pay the amount owed under the post pay method within a prescribed time period (e.g., within five business days), or otherwise get a negative rating.

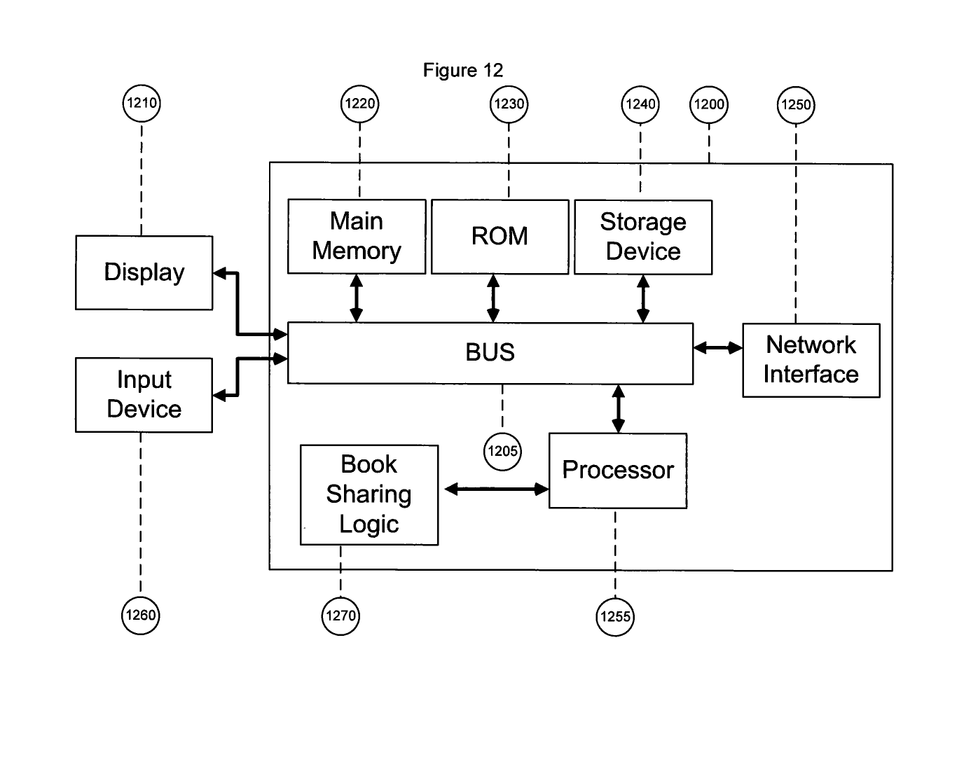

In some embodiments, in order to reduce the costs associated with passing on a book to another user, a GPS device or other type of position locating device, such as one provided on a user equipment of the user (e.g., the user's cell phone or laptop computer), indicates the current location of the person who currently has the book and the person who desires to borrow the book. Based on such information, if it is determined that these two persons are currently located within a particular distance of each other, e.g., 200 miles or less, the person who desires to borrow the book is notified of this, such as by a text message, an email message, or a prerecorded telephone message, and given the option to contact the person who currently has the book to arrange to pick up the book in-person from that person, so as to save on costs associated with mailing the book from person to person. To make it financially viable for both persons, the mailing costs saved can be divided up evenly between those two persons, so that if a book would have cost $10 to mail in bulk, both persons would save $5 in the book costs by having an in-person transfer of the book from one person to another person. FIG. 12 shows a position location unit 1290, e.g., a GPS unit or other type of position locator, which can be used in some embodiments to determine if the seller and the buyer are relatively close to one another and thus can exchange the book by direct contact between them instead of having the book mailed from the seller to the buyer.

Based on the current location of the buyer and the seller, as provided to the computer 1200 of the book sharing web site by user equipment associated with the buyer and the seller, if it is determined that their respective locations are within a predetermined distance of each other (e.g., 200 miles or less), each is notified of the option to directly transfer the book from the seller to the buyer, so that both can potentially save money by not having to pay any mailing fees. The notification can be by email, text message and/or pre-recorded telephone message, to user equipment associated with the seller and the buyer (as provided to the computer 1200 when the seller and the buyer registered onto the book sharing web site). Information used for contact between the seller and the buyer can be by the book sharing web site providing contact information to each of them, such as a telephone number or email address, so that they can arrange between themselves as to a convenient place and time to transfer the book from the seller to the buyer.

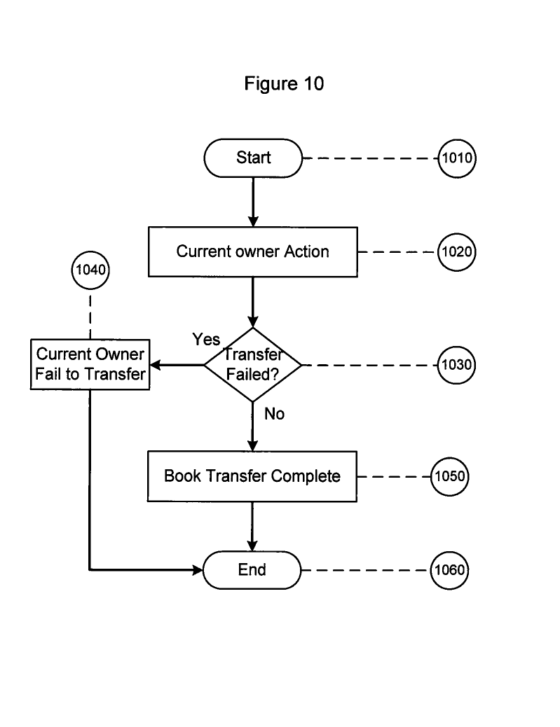

FIG. 10 illustrates the process of transfer of a book to subsequent user according to an embodiment. This process is applicable to both pre pay as well as post pay method of book sharing. When a user requests for a book that is in the book sharing system, the current user is notified of the request. If the current user fails to pass the book to the next user, the system computes the impact of failed transfer. If the user passes the book successfully to the next user, the system is updated and the current user of the book is changed to the new user of the book. In some embodiments, each user is responsible for passing the book to the next user. That can involves paying the fees associated with sending the book to the next user (e.g., postage fees), and for physically sending the book on its way to the next user.

The process starts at Start Block 1010 in FIG. 10, which starts when a user finds a book in the book sharing system, and successfully makes the request to become the next user of the book this mechanism is used to complete the transfer of the book to the next user.

The process proceeds to Block 1020, in which a user requests to use the book in the book sharing system, the current user of the book is notified.

In Block 1030, the process determines whether the transfer of the book was successful or not. If the transfer is successful (‘No’ line output from Block 1030), the process proceeds to Block 1050, and control is transferred to a component (e.g., software application) that handles the completion of book transfer. If the transfer fails (‘Yes’ line output from Block 1030), the process proceeds to Block 1040, and control is transferred to a component (e.g., software application) that handles the Failure of Book Transfer.

In more detail, in Block 1040, the transfer of the book from the current user to next user is determined to have failed, and the book sharing system processes the failure to transfer of the book.

In Block 1050, the transfer of the book is determined to have been successful, and funds are settled as per the book sharing method associated with the book, to complete the book transfer.

The process then proceeds from Block 1050 to End Block 1060, which is the end of the process of transfer of an existing book in the book sharing system to another user.

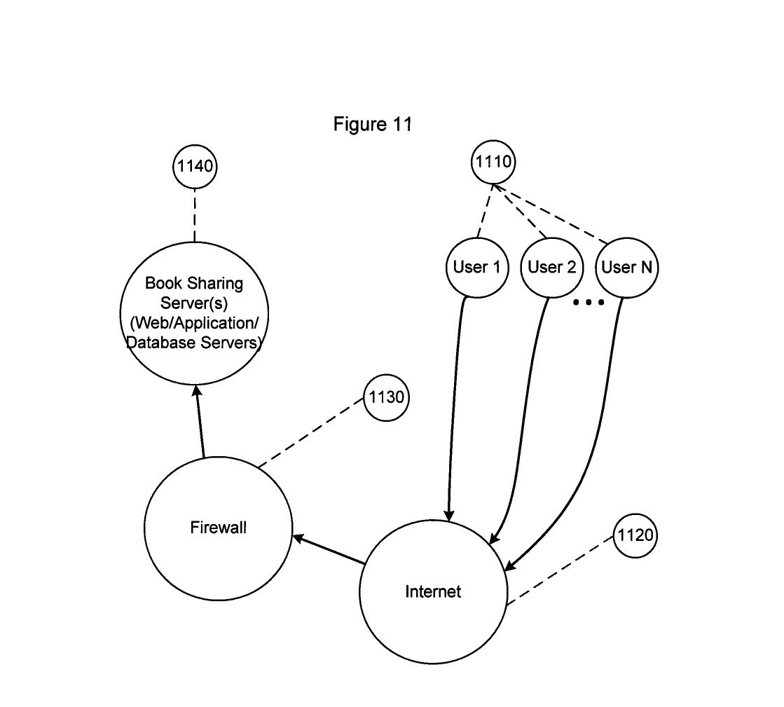

FIG. 11 shows a network communications structure for implementing a book sharing setup, management system and method according to one or more embodiments. In some embodiment, the book sharing system is implemented as a software application that can be utilized by users of the world wide web (the Internet). The book sharing system can be offered to users 1110 via an internet connection 1120, which passes through a firewall 1130 to one or more book sharing system servers 1140 that corresponds to a web-based book sharing system. A user 1110 can log into the book sharing website (as provided and controlled by the book sharing server 1140) provided by the book sharing system. Through the website, users can interact with the book sharing system via the book sharing web application that they can download from the book sharing servers 1140 and then run on their respective computers. In more detail, a user 1110 can become a registered member of the book sharing site, browse the books, make requests for book sharing, pay for book sharing, and collect payments from book sharing system, all via the internet 1120. The firewall 1130 is provided to ensure security with respect to the personal information provided by the registered user to enter into one or more book sharing.

FIG. 12 illustrates a depiction of a computing system 1200 that can perform book sharing setup, and management according to the embodiments described above. The computing system 1200 includes a bus 1205 or other communication mechanism for communicating information and a processor 1250 coupled to the bus 1205 for processing information. The computing system 1200 also includes main memory 1220, such as a random access memory (RAM) or other dynamic storage device, coupled to the bus 1205 for storing information, and instructions to be executed by the processor 1250. The tools described by way of flow charts of FIGS. 1-6 and 10 may be stored in the main memory 1220 or in the storage device 1240, for example. Main memory 1220 can also be used for storing position information, temporary variables, or other intermediate information during execution of instructions by the processor 1250. The computing system 1200 may further include a read only memory (ROM) 1230 or other static storage device coupled to the bus 1205 for storing static information and instructions for the processor 1240. A storage device 1240, such as a solid state device, magnetic disk or optical disk, is coupled to the bus 1205 for persistently storing information and instructions. Network interface 1255 provides a connection to a network, such as the Internet or a Local Area Network (LAN) or a Wide Area Network (WAN). Book Sharing Setup, and Management logic 1270, which may be stored in main memory 1220, ROM 1230 and/or storage device 1240, and which also may include some hardware logic components, is utilized by processor 1255 to perform the book sharing management described above with respect to various embodiments.

The computing system 1200 may be coupled via the bus 1205 to a display 1210, such, as a liquid crystal display, or active matrix display, for displaying information to a user. An input device 1260, such as a keyboard including alphanumeric and other keys, may be coupled to the bus 1205 for communicating information, and command selections to the processor 1250. In another implementation, the input device 1260 has a touch screen display 1210. The input device 1260 can include a cursor control, such as a mouse, a trackball, or cursor direction keys, for communicating direction information and command selections to the processor 1250 and for controlling cursor movement on the display 1210.

It will be appreciated that the embodiments described above and illustrated in the drawings represent only a few of the many ways of implementing embodiments for providing book sharing setup, management and funds management.

The environment of the present invention embodiments may include any number of computer or other processing systems (e.g., client or end-user systems, server systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system (e.g., desktop compatible, laptop, PDA, mobile devices, etc.), and may include any commercially available operating system and any combination of commercially available and custom software (e.g., browser software, communications software, server software, etc.). These systems may include any types of monitors and input devices (e.g., keyboard, mouse, voice recognition, etc.) to enter and/or view information.

It is to be understood that the software of the present invention embodiments may be implemented in any desired computer language and could be developed by one of ordinary skill in the computer arts based on the functional descriptions contained in the specification and flow charts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client and server systems, and/or any other intermediary processing devices. The software and/or algorithms described above and illustrated in the flow charts may be modified in any manner that accomplishes the functions described herein. In addition, the functions in the flow charts or description may be performed in any order that accomplishes a desired operation.

The software of the present invention embodiments may be available on a recordable or computer useable medium (e.g., magnetic or optical mediums, magneto-optic mediums, floppy diskettes, CD-ROM, DVD, memory devices, etc.) for use on stand-alone systems or systems connected by a network or other communications medium.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information (e.g., book detail information, User information, funds and pricing information, registered users personal information, etc.). The database system may be implemented by any number of any conventional or other databases, data stores or storage structures (e.g., files, databases, data structures, data or other repositories, etc.) to store information. The database system may be included within or coupled to the server and/or client systems. The database systems and/or storage structures may be remote from or local to the computer or other processing systems, and may store any desired data (e.g., book detail information, user information, funds and pricing information, registered users personal information, etc.). Further, various may be implemented by any conventional or other data structures (e.g., files, arrays, lists, stacks, queues, etc.) to store information, and may be stored in any desired storage unit (e.g., database, data or other repositories, etc.).

The present invention embodiments are not limited to the specific tasks or algorithms described above, but may be utilized for improving the performance of hash tables other than open addressing hash tables.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a tangible (non-transitory) computer readable medium may be transmitted using any appropriate medium, including but not limited to wireless, wired, optical fiber cable, RF, etc., or any suitable combination of the foregoing.

Computer program code for carrying out operations for aspects of the present invention may be written in any combination of one or more programming languages, including an object oriented programming language such as Java (Java and all Java-based trademarks and logos are trademarks of Oracle or Sun Microsystems, Inc. in the United States, other countries, or both), Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer-implemented method for book sharing and funds management, comprising:
receiving a request, by a server, for a particular book to be shared, the request being made by a current user of a book sharing website;
determining, by the server, if the particular book exists in a database of books owned and/or controlled by the website;
if the book is determined to exist in the database, providing, by the server, details of book sharing to the current user, the details including fees to be paid by the current user that is associated with sharing the particular book;
if the book is determined to exist in the database and the current user has provided input to the website for paying the fees for sharing the particular book, notifying, by the server, all previous users who have shared the particular book from the website of a credit to be provided to their respective accounts regarding fees associated with the previous users having previously shared the particular book from the website; and
notifying, by the server, a previous user who is currently in possession of the book to provide the book to the current user at some later point in time.

2. The method according to claim 1, further comprising:
determining if a user of the website is a registered user or not;
if the user of the website is determined to not be registered onto the website, providing the user with access to books for sharing on the website,
wherein the user is not allowed to obtain any books from the website until the user has registered onto the web site.

3. The method according to claim 1, wherein the details of book sharing comprise:
information regarding pre paid book sharing; and
information regarding post paid book sharing,
wherein, based on receipt of input from the current user regarding whether the current user wants to use the pre paid book sharing or the post paid book sharing, determining the fees to be requested from the current user for enabling the current user to share the particular book from the website.

4. The method according to claim 3, wherein the information regarding pre paid book sharing and post paid book sharing are displaying on a single display of user equipment of the current user, for side-by-side comparison by the current user to determine which one to use to obtain the book.

5. The method according to claim 4, wherein the user equipment of the current user includes at least one of a smart phone, a tablet computer, and a personal computer.

6. The method according to claim 3, wherein a total cost of the book is distributed among all previous users of the particular book and the current user who will be getting the particular book.

7. The method according to claim 3, wherein the pre paid book sharing comprises a first user of the book paying an entire cost of the book, and wherein all borrowings of the book result in the previous users of the book getting refunded a portion of the entire cost of the book based on payments made by future borrowers of the book.

8. The method according to claim 3, wherein the post paid book sharing comprises a first user of the book paying a preset fraction of an entire cost of the book, and wherein the first user is responsible for paying a remaining portion of the entire cost of the book if the book is not borrowed by another user within a predetermined time after the current user has agree to share the book.

9. The method according to claim 8, wherein the current user is not responsible for paying any remaining portion of the uncollected cost of the book if the book is borrowed by another user within the predetermined time after the current user agreed to share the book, and wherein responsibility for paying the outstanding portion of the entire cost of the book shifts to another user who has obtained the book from the first user.

10. A book sharing and funds management system provided on the Internet, comprising:
an input unit configure to receive a request, to a website, for a particular book to be shared, the request being made by a current user of the website;
a determining unit configured to determine if the particular book exists in a database of books owned and/or controlled by the website;
a shared book fees determining unit configured to, if the determining unit has determined that the particular book exists in the database, providing details of book sharing to the current user, the details including fees to be paid by the current user that is associated with sharing the particular book;
a notification unit configured to, if the determining unit has determined that the particular book exists in the database and the current user has provided information to the input unit for paying the fees for sharing the particular book, notify all previous users who have shared the particular book from the website of a credit to be provided to their respective accounts regarding fees associated with the previous users having previously shared the particular book from the website,
wherein the book sharing and funds management system notifies another user currently in possession of the book to provide the shared book to the current user.

11. The system according to claim 10, further comprising:
a registration determining unit configured to determine if a user of the website is a registered user or not,
wherein, if the user of the website is determined to not be registered onto the website, the user is provided with access to books for sharing on the website,
wherein the user is not allowed to obtain any books from the website until the user has registered onto the web site.

12. The system according to claim 10, wherein the details of book sharing comprise:
information regarding pre paid book sharing; and
information regarding post paid book sharing,
wherein, based on receipt of input from the current user regarding whether the current user wants to use the pre paid or the post paid book sharing, the fees to be requested from the user for enabling the current user to share the particular book from the website are determined.

13. The system according to claim 10, where a total cost of the particular book is distributed among all previous users of the particular book and the current user who will be getting the particular book.

14. The system according to claim 12, wherein the information regarding pre paid book sharing and post paid book sharing are displaying on a single display of user equipment of the current user, for side-by-side comparison by the current user to determine which one to use to obtain the book.

15. The system according to claim 14, wherein the user equipment of the current user includes at least one of a smart phone, a tablet computer, and a personal computer.

16. The system according to claim 14, wherein the pre paid book sharing comprises a first user of the book paying an entire cost of the book, and wherein all borrowings of the book result in previous users of the book getting refunded a portion of the entire cost of the book based on payments made by future borrowers of the book.

17. The system according to claim 14, wherein the post paid book sharing comprises a first user of the book paying a preset fraction of an entire cost of the book, and wherein the first user is responsible for paying a remaining portion of the entire cost of the book if the book is not borrowed by another user within a predetermined time after the current user has obtained the book.

18. The system according to claim 17, wherein the first user is not responsible for paying the remaining portion of the entire cost of the book if the book is borrowed by another user within the predetermined time after the current user has obtained the book, and wherein responsibility for paying the remaining portion of the entire cost of the book shifts to another user who has obtained the book from the first user.

19. A server provided for a book sharing web site, comprising:
a memory accessible by the server and configured to store information regarding at least books available for borrowing by users; and
the server including a processor that performs the following book sharing functions:
receiving a request for a particular book to be shared, the request being made by a current user of a book sharing website;
determining if the particular book exists in a database of books owned and/or controlled by the website;
if the book is determined to exist in the database, providing details of book sharing to the current user, the details including fees to be paid by the current user that is associated with sharing the particular book;
if the book is determined to exist in the database and the current user has provided input to the website for paying the fees for sharing the particular book, notifying all previous users who have shared the particular book from the website of a credit to be provided to their respective accounts regarding fees associated with the previous users having previously shared the particular book from the website; and
notifying a previous user who is currently in possession of the book to provide the book to the current user at some later point in time.

20. The server according to claim 19, wherein the details of book sharing comprise:
information regarding pre paid book sharing; and
information regarding post paid book sharing,
wherein, based on receipt of input from the current user regarding whether the current user wants to use the pre paid book sharing or the post paid book sharing, determining the fees to be requested from the current user for enabling the current user to share the particular book from the website.
